(19) United States
(12) Patent Application Publication
(10) Pub. No.: US 2006/0225669 A1
(43) Pub. Date: Oct. 12, 2006

(54) Group tether device for children

(76) Inventor: Delia Fontaine, Seattle, WA (US)

Correspondence Address: WEST & ASSOCIATES, A PC, 2815 MITCHELL DRIVE, SUITE 209, WALNUT CREEK, CA, 94598, US

(21) Appl. No.: 11/103,828

(22) Filed: Apr. 12, 2005

(51) Int. Cl. A62B 35/00

(52) U.S. Cl. 119/770

(57) ABSTRACT

A device for managing a group of children on an outing in an urban environment. A central member is held by an adult by a handle at each of the proximal and distal ends, while multiple cross-members attach by their proximal ends to various points on the central members and at their distal ends to a child's wrist. The distal ends of the cross members may have a visually or textually-designated grasping area to encourage the child to actively hold onto the member. In addition, the apparatus may include a sensing device that is triggered by a child breaking free from the wrist attachment and would alert the adults managing the group.

### BACKGROUND

1. Field of the Invention

The present disclosure is for a device that helps childcare staff manage a group of children during an outing, especially in a busy urban environment.

2. Background

Day care facilities often take the children on outings. However, managing a group and controlling the children's movement can be challenging. Childcare workers must take great care to prevent children from running off and into potential danger, particularly in a busy urban environment. Children, commonly lacking better judgment, can and will run into traffic at the first sight of something they find interesting. Since day care centers are often understaffed, childcare workers need a way for one or two adults to control multiple children when they go on an outing.

Several devices exist that control the movement of either an individual child or multiple children. The CHILD SAFETY TETHER by Small Planet Children's Products (Irvine, Calif.) is an example of such a device. The child wears a harness, to which an adult-held leash is attached. U.S. Pat. No. 4,638,764 issued to Anderson on Jan. 27, 1987, entitled “Security System,” shows an even simpler tether with wrist straps at either end to connect an adult and a child. However, neither of these devices would be of much use to a few adults in controlling a larger group of children.

Some devices do exist to control a group of children. U.S. Pat. No. 4,563,981 issued to Kramer on Jan. 14, 1986, entitled “Group Tether Apparatus,” shows a main handle held by the leader with multiple strings having multiple handles connected to it. Similarly, U.S. Pat. No. 5,447,121 issued to Spence on Dec. 17, 1992, entitled “Escort Safety Line for Children,” also shows a plurality of handles attached to a central member. U.S. Pat. No. 6,422,176 issued to Tonuzi on Jul. 23, 2002, entitled “Guide Rope for Small Children,” shows a central nylon rope with a plurality of intermediate cross ropes with handles for gripping. However, none of these has means to further secure the child to the apparatus and relies on the child to hold on to a handle at all times to be effective. There are no means to ensure the safety of a child in the emergency situation when the child decides, in an instant, to run off.

Some devices for group control have included means to secure the children, as well as a modular system to vary the length and capacity. U.S. Pat. No. 5,423,292 issued to Hall on Jun. 19, 1995, entitled “Safety Harness for Children,” shows a central strap with transverse straps permanently stitched in place. Wrist straps then connect to the ends of the transverse straps to secure each child. Although the children are now secure, the device does not allow for much flexibility in terms of varying the capacity. U.S. Pat. No. 6,047,665 issued to Deveaux on Apr. 11, 2000, entitled “Multi-child Modular Tether-harness Combination,” is similar to the Hall device, but allows for accommodating an indefinite number of children by adding and removing modules that have the transverse strap. This modular design allows for variations in capacity, but the system of many sub-units and quick-release connectors can be cumbersome. It would be time-consuming to properly set up the device, especially if a daycare provider has different numbers of children to take care of on a regular basis. Further, the connectors may present a pinch-hazard to small fingers.

What is needed is a device for managing a group of children on an outing that is simple, inexpensive to produce, allows for supervision at both ends of the line, and secures the children while teaching them to hold onto the rope themselves. Further, the device will give young children something to hold onto to help balance their walk.

### BRIEF DESCRIPTION OF THE DRAWINGS

FIG. 1 depicts a perspective view showing an embodiment of the instant device.

FIG. 1a depicts a detail of the distal end of the cross-member and attachment strap.

FIG. 2 depicts another embodiment of the instant device with warning sensors.

FIG. 3 depicts a perspective view of the device in use by two adults supervising a group of children.

FIG. 4 depicts a further embodiment of the instant device with rigid pipe segments encasing the rope in between the transverse member connection points.

### DETAILED DESCRIPTION

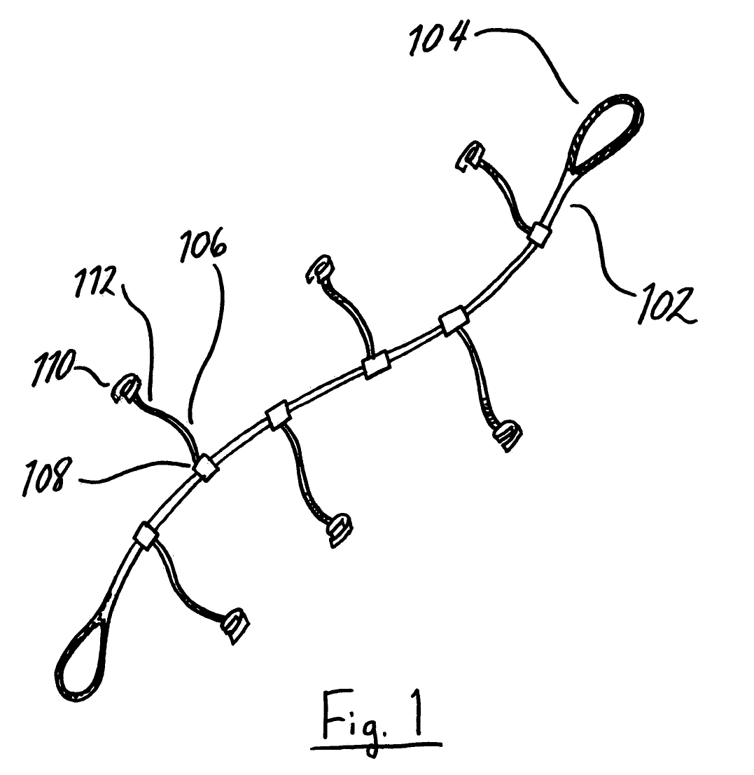

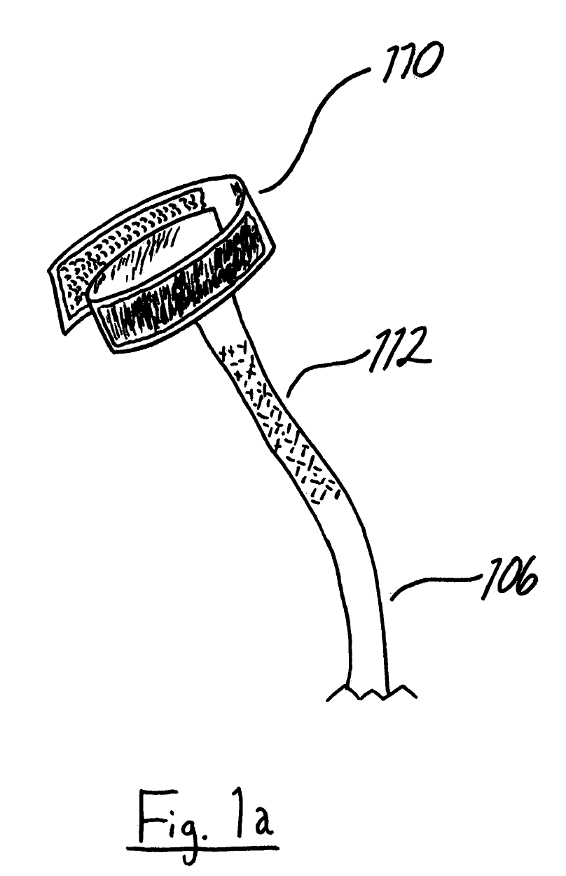

FIG. 1 depicts an embodiment of the tether device 101. A central member 102 has two connected or integrated handles 104, one at its proximal and one at its distal end. At their proximal ends, shorter transverse members 106 are flexibly but firmly connected to or are integrated with the central member 102 at multiple points. Both the central 102 and transverse 106 members may be made of any material convenient or known, including, but not limited to: nylon or cloth rope, cord, or webbed strapping. In the embodiment depicted, connectors 108 are shown to join the transverse members 106 to the central member 102. The connectors 108 may be made of any known or convenient material such as plastic, hard rubber, or metal. Further, these connectors 108 may create a permanent or removable connection.

A security wrist strap 110 is connected to the distal end of a transverse member 106. The wrist strap 110 depicted has a hook-and-loop such as a Velcro® closure that can close the strap and secure it to a child's wrist. The distal end of transverse members 106 also has a textured or colored region 112 adjacent to the strap 110 connection onto which the child is to grasp.

FIG. 1a shows a detail of the distal end of the transverse member 106. The security wrist strap 110 is shown having a Velcro® surface to secure it to a child's wrist. In further embodiments, the strap may be made of a soft, padded material for added comfort and safety around a child's wrist. The grasping region 112 may be brightly colored, textured, or both to encourage the child to grasp and hold onto the transverse member 106.

In a further embodiment of the device, the security wrist strap 110 could be detachably, yet securely attached to the distal end of the transverse member 106 by any known or convenient means. The security wrist strap 110 could remain attached to a child's wrist while at day care and then connected to the transverse member 106 when the group goes on an outing. This would facilitate quickly and easily connecting the children to the device and the security wrist straps 110 can also act as an identification nametag if labeled with a child's name. The security wrist straps 110 and transverse members 106 can also be produced in fun colors and patterns so that the children will enjoy using the device like a game or toy, rather than feel subjected to it.

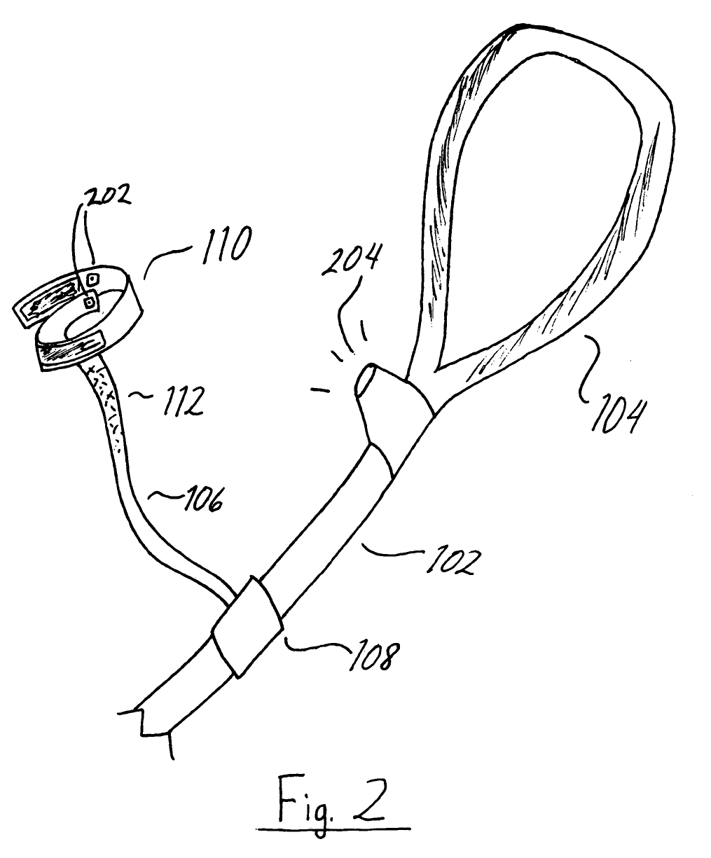

FIG. 2 shows an alternate embodiment of the device in which it is equipped with a sensor circuit to alert an adult at either end of the central member 102 if a child breaks free of a transverse member 106. The circuit includes electrical couplings 202 that couple when the security wrist strap 110 is closed. These electrical connectors 202 are connected in an electrical circuit to an auditory or visual signaling device 204 located adjacent to a handle 104 at either or both ends of the central member 102. If a child breaks free of the security wrist strap 110, the electrical couplings 202 are disconnected, the circuit is interrupted, and the sensor device 204 is activated. This provides an added measure of security in alerting the supervising adults in the event that they momentarily did not have an eye on the children.

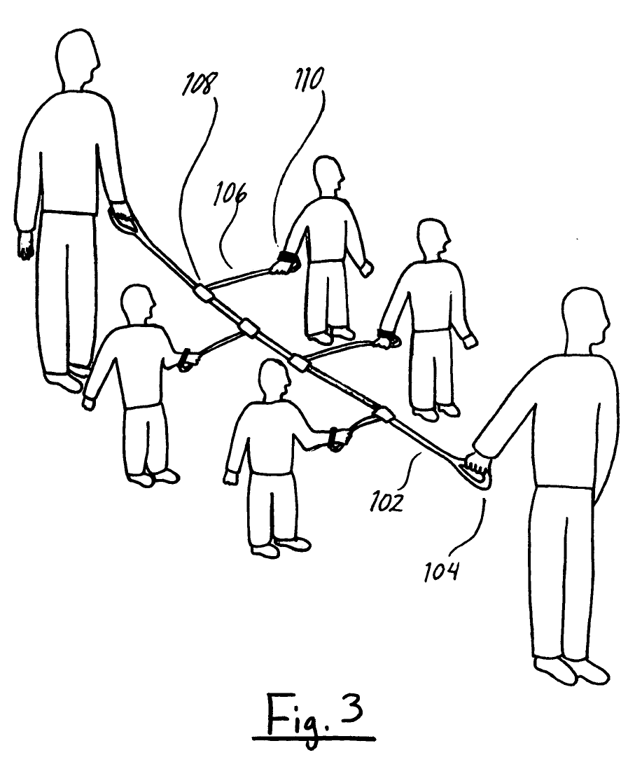

FIG. 3 shows an embodiment of the instant device in operation. Each child in the group would grasp the distal end of a transverse member 106 in the designated grasping region 112. An adult would wrap the strap 110 around the child's wrist to for added security. Assuming two adults are supervising the group, each would take hold of either the handle 104 at the proximal or distal end of the central member 102. This allows one adult to lead the group, while the other can supervise from the rear of the line. The device could also be used by one adult only holding a handle 104 at the proximate end, walking behind the children.

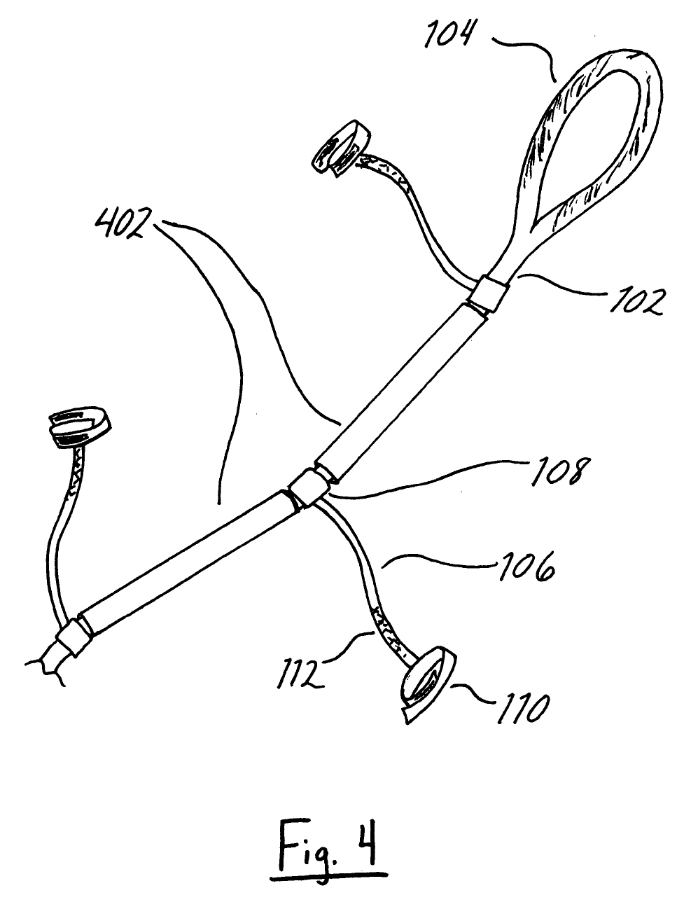

FIG. 4 shows another embodiment of the instant device with rigid pipe segments 402 encasing the central member 102 in between the transverse member connection points 108. These rigid pipes 402 assist in preventing the children from bunching together while walking. Alternatively, the connectors 108 could be fastened onto the central member 102 in a manner such that they do not slide along the axis between the proximate and distal ends.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A device for safely taking groups of children on outings, comprising:
a central member having a distal and proximal end;
at least one handle connected to one end of said central member;
a plurality of transverse members of length less than that of the central member and having a distal and proximal end;
said plurality of transverse members being connected fast to or integrated with various points on said central member at their proximal ends; and
a wrist strap with a closure attached to the distal end of each transverse member.

2. The device of claim 1, in which said transverse members are removable.

3. The device of claim 1, further comprising a grasping area at the distal end of each transverse member.

4. The device of claim 3, in which said grasping area is designated by color, texture, or a combination of both.

5. The device of claim 1, in which said central member is constructed of a flexible material.

6. The device of claim 1 in which said central member is constructed of a semi-rigid material.

7. The device of claim 1, wherein said wrist strap is detachable from the transverse member.

8. The device of claim 2, in which said central member is encased by rigid members between the attachment points of said transverse members.

9. The device of claim 1, further comprising:
an electrical circuit running through the straps at the distal end of each transverse member and a sensor located proximate to one end of the central member;
wherein the breaking of said electrical circuit via the release of one of the straps produces an alarm.

10. The device of claim 8 in which the sensor emits an auditory signal, visual signal, or both.
